(19) United States
(12) Patent Application Publication
(10) Pub. No.: US 2026/0097448 A1
(43) Pub. Date: Apr. 9, 2026

(54) Laser Welding Apparatus for Secondary Battery

(71) Applicant: SK On Co., Ltd., Seoul (KR)

(72) Inventors: Kang San KIM, Daejeon (KR); Sang Jun PARK, Daejeon (KR); Ju Hyeong BAE, Daejeon (KR); Do Wan CHA, Daejeon (KR)

(21) Appl. No.: 19/345,032

(22) Filed: Sep. 30, 2025

(30) Foreign Application Priority Data
Oct. 4, 2024 (KR) 10-2024-0135069

(51) Int. Cl. B23K 26/066; B23K 26/073; B23K 26/244; B23K 101/38; H01M 10/04; H01M 50/536; H01M 50/54

(52) U.S. Cl. CPC B23K 26/066; B23K 26/073; B23K 26/244; H01M 10/0481; B23K 2101/38; H01M 50/536; H01M 50/54

(57) ABSTRACT

Proposed is a laser welding apparatus for a secondary battery including a lower clamp configured to support a joint area of a plurality of electrode tabs extending from an electrode assembly and an electrode lead stacked on the plurality of electrode tabs, an upper clamp configured to press the joint area of the plurality of electrode tabs and the electrode lead and to have a through hole therein, and a laser generator configured to emit a laser beam, wherein the laser beam passes through the through hole to weld the plurality of electrode tabs and the electrode lead to enable electrical connection.

### CROSS REFERENCE TO RELATED APPLICATION

The present application claims priority to Korean Patent Application No. 10-2024-0135069, filed Oct. 4, 2024, the entire contents of which is incorporated herein for all purposes by this reference.

### BACKGROUND

### Technical Field

The present disclosure relates to a laser welding apparatus for a secondary battery and, more particularly, to an apparatus capable of uniting a plurality of electrode tabs and electrode leads by laser welding.

### Description of the Related Art

Secondary batteries, which can be charged and discharged repeatedly, are widely used as power sources for portable electronic devices like mobile phones and laptops, driven by the advancement of the information and communication and display industries. In addition, with the recent increase in interest in environmental issues, research on eco-friendly transportation such as electric vehicles (EVs) and hybrid electric vehicles (HEVs) that can replace vehicles that use fossil fuels is actively being conducted, and the demand for secondary batteries as a power source for the eco-friendly transportation is on the rise.

A typical secondary battery is composed of an electrode assembly, a casing containing the electrode assembly and an electrolyte, and an electrode lead connected to the electrode assembly and extending out of the casing. The electrode assembly can be configured as a jelly-roll type in which electrode plates and separators are wound, or as a stacked-type in which electrode plates and separators are alternately laminated. An electrode plate consists of a coated portion where an active material is applied on a current collector and a non-coated portion where no active material is applied on the same current collector. An electrode tab is formed by notching the non-coated portion, and an electrode lead is welded to the electrode tab to enable electrical connection. In this case, the electrode plate is composed of a positive electrode plate and a negative electrode plate.

As described above, to connect an electrode tab to an electrode lead, multiple electrode tabs extending from an electrode assembly can first be pre-welded using ultrasonic welding to be aligned and bonded. Then, main welding is performed in which the electrode lead is laser welded to the aligned electrode tabs. Typically, multiple electrode tabs and an electrode lead can be melt-bonded by laser welding along with ultrasonic welding.

As is well known to those skilled in the art, ultrasonic welding requires increasing ultrasonic output depending on the stacking height of multiple thin-film electrode tabs, and the resulting vibration can cause deformation or damage to the electrode tabs. If a damaged electrode tab is laser welded to the electrode lead, the welding uniformity and reliability will likely deteriorate.

Accordingly, there is a need for a new proposal for a welding technology that improves the bonding stability of multiple electrode tabs and electrode leads.

### SUMMARY

According to an aspect of the present disclosure, provided is a laser welding apparatus for a secondary battery, the apparatus being capable of stably welding a plurality of electrode tabs and an electrode lead in close contact with each other.

A laser welding apparatus for a secondary battery according to the present disclosure includes: a lower clamp configured to support a joint area of a plurality of electrode tabs extending from an electrode assembly and an electrode lead stacked on the plurality of electrode tabs; an upper clamp configured to press the joint area of the plurality of electrode tabs and the electrode lead and to have a through hole therein; and a laser generator configured to emit a laser beam, wherein the laser beam may pass through the through hole to weld the plurality of electrode tabs and the electrode lead to enable electrical connection.

In the present disclosure, the lower clamp may be arranged to be able to move up and down.

In the present disclosure, the upper clamp may be positioned opposite to the lower clamp and may be arranged to be able to move up and down.

Preferably, the present disclosure may further include a mask interposed between the upper clamp and the laser generator, and configured to have at least one opening therein through which the laser beam passes.

In the present disclosure, the opening and the through hole may be arranged in a row along a stacking direction of the joint area.

Alternatively, the mask may be detachably mounted on the upper clamp.

In another embodiment of the present disclosure, the upper clamp may be provided with a stepped portion on an inner surface of the through hole so that an upper side of the through hole is expanded stepwise.

In addition, the upper side of the through hole may be formed with a size and shape corresponding to a bottom of the mask.

In still another embodiment of the present disclosure, the through hole of the upper clamp may be formed with a trapezoidal cross-section with a width that gradually narrows from top to bottom, and the bottom of the mask may be formed with a trapezoidal cross-section to correspond to the through hole.

In addition, the through hole may be formed in a cross-sectional shape of an isosceles trapezoid with symmetrically arranged inner slopes that are not parallel to each other on opposite sides, and the bottom of the mask may be formed in a cross-sectional shape of an isosceles trapezoid with symmetrically arranged outer slopes that are not parallel to each other on opposite sides.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, a plurality of electrode tabs and an electrode lead can be welded after the electrode tabs are aligned without pre-welding, which only bonds the electrode tabs by applying ultrasonic vibration.

Accordingly, the present disclosure can save welding equipment, working time, and man-hours, as well as minimize damage to electrode tabs that may occur during the welding process.

Furthermore, the present disclosure can improve the quality of welding for bonding a plurality of electrode tabs and bonding the electrode tabs and an electrode lead using laser welding.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an exploded perspective view schematically showing a pouch-type secondary battery;

FIG. 2 is a schematic view showing a laser welding apparatus for a secondary battery according to an embodiment of the present disclosure, and is a view showing the arrangement state of the apparatus in a joint area of a plurality of electrode tabs and an electrode lead shown in FIG. 1;

FIG. 3 is a cross-sectional view schematically showing a process of bonding a plurality of electrode tabs and an electrode lead using a laser welding apparatus for a secondary battery according to an embodiment of the present disclosure;

FIG. 4 is a schematic view showing the main parts of a laser welding apparatus for a secondary battery according to another embodiment of the present disclosure;

FIG. 5 is a cross-sectional view schematically showing a process of bonding a plurality of electrode tabs and an electrode lead using a laser welding apparatus for a secondary battery according to another embodiment of the present disclosure;

FIG. 6 is a schematic view showing the main parts of a laser welding apparatus for a secondary battery according to still another embodiment of the present disclosure; and

FIG. 7 is a cross-sectional view schematically showing a process of bonding a plurality of electrode tabs and an electrode lead using a laser welding apparatus for a secondary battery according to still another embodiment of the present disclosure.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

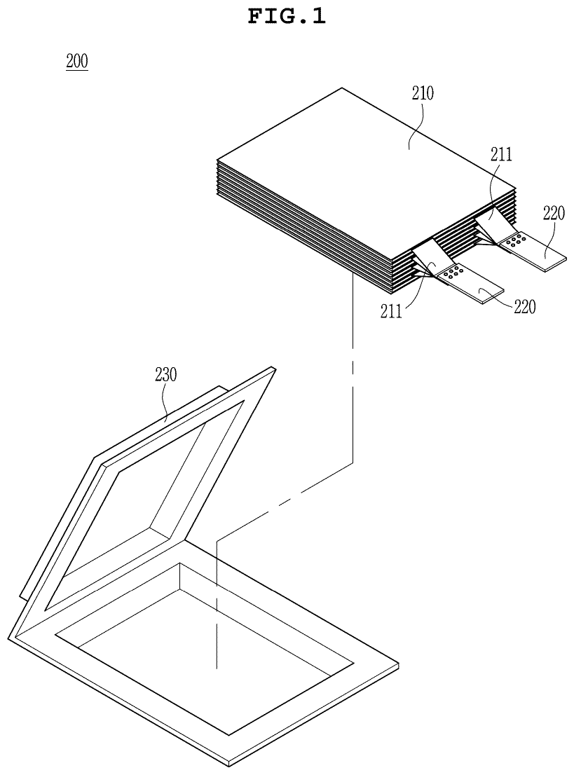

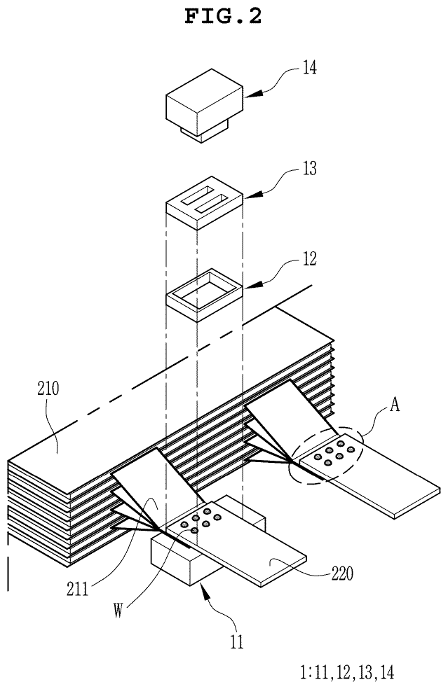

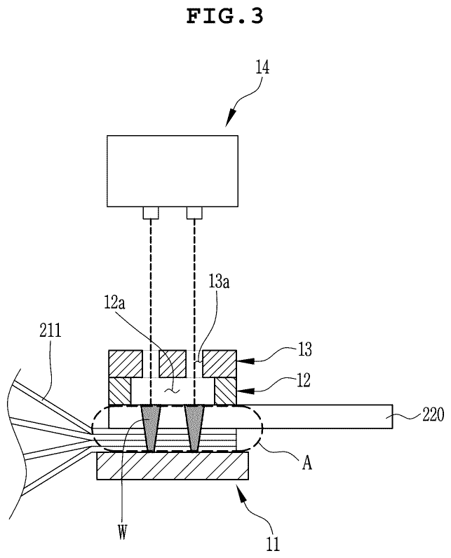

FIG. 1 is an exploded perspective view schematically showing a pouch-type secondary battery, and FIG. 2 is a schematic view showing a laser welding apparatus for a secondary battery according to an embodiment of the present disclosure. FIG. 3 is a cross-sectional view schematically showing a process of bonding a plurality of electrode tabs and an electrode lead using a laser welding apparatus for a secondary battery according to an embodiment of the present disclosure.

The present disclosure relates to a laser welding apparatus for a secondary battery capable of bonding a plurality of stacked electrode tabs and an electrode lead, and preferably, the present disclosure is configured to weld a plurality of electrode tabs and an electrode lead by applying pressure in the stacking direction by laser welding, without performing ultrasonic welding.

In addition, the present disclosure is configured to allow bonding of a plurality of electrode tabs and an electrode lead by non-contact laser welding.

As is widely known to those skilled in the art, a secondary battery 200, for example, a pouch-type secondary battery, includes: an electrode assembly 210, an electrode lead 220 electrically connected to the electrode assembly 210 and extending outward; and a battery casing 230 (or pouch outer shell) that encloses and seals the electrode assembly 210 such that the electrode lead 220 is exposed to the outside while providing a space to accommodate an electrolyte together with the electrode assembly 210 as shown in FIG. 1.

In the present disclosure, the electrode assembly 210 may be a jelly-roll type electrode assembly formed by winding in a spiral shape with a separator interposed between positive and negative electrode plates, or may be a stacked-type electrode assembly in which a positive electrode plate, a separator, and a negative electrode plate are repeatedly laminated, but is not limited thereto. The present disclosure is not limited to a specific arrangement method but is applicable to any electrode assembly that can have a predetermined thickness in the stacking direction (or the vertical direction in the drawing) by alternately stacking electrode plates and separators. A positive electrode tab, which is a positive electrode non-coated portion where no positive electrode active material is applied to a positive electrode plate, is electrically connected to the electrode lead 220 extending outward from the battery casing 230 by laser welding, for example. Correspondingly, a negative electrode tab, which is a negative electrode non-coated portion where no negative electrode active material is applied to a negative electrode plate, is electrically connected to the electrode lead 220 extending outward from the battery casing 230 by laser welding, for example. In this case, each of the positive and negative electrode tabs is composed of the electrode tab 211.

A plurality of electrode tabs 211 extending from each of the positive and negative electrode plates may be formed in a structure protruding outward from one side of the electrode assembly 210 as shown, or, unlike the drawing, may be formed in a structure protruding outward from opposite sides of the electrode assembly 210.

In the present disclosure, a joint area A where the electrode tabs and an electrode lead are bonded in an overlapping state may be formed in a structure in which a plurality of electrode tabs 211 is arranged in a stacked manner with the same polarity and then welded to one electrode lead 220.

A laser welding apparatus 1 for a secondary battery according to an embodiment of the present disclosure is proposed to bond the plurality of electrode tabs 211 and the electrode lead 220, and may include: a lower clamp 11 and an upper clamp 12 for holding the plurality of electrode tabs 211 and the electrode lead 220; and a laser generator 14 that emits a laser beam to the joint area A of the plurality of electrode tabs 211 and the electrode lead 220 to join the plurality of electrode tabs 211 and the electrode lead 220.

In other words, the present disclosure includes: the lower clamp 11 configured to support the joint area A of the plurality of electrode tabs 211 extending from the electrode assembly 210 and the electrode lead 220; the upper clamp 12 configured to press the joint area A of the plurality of electrode tabs 211 and the electrode lead 220 and to form a through hole 12a therein; and the laser generator 14 that emits a laser beam. In this case, the laser beam may pass through the through hole 12a to weld the plurality of electrode tabs 211 and the electrode lead 220 to enable electrical connection.

The present disclosure may further include a mask 13 for selectively emitting a laser beam to multiple locations on the aforementioned joint area A. The mask 13 is interposed between the upper clamp 12 and the laser generator 14, and has one or more openings 13a therein through which a laser beam passes.

The laser welding apparatus 1 for a secondary battery according to an embodiment of the present disclosure includes the lower clamp 11.

The lower clamp 11 is a component that supports the plurality of electrode tabs 211 and the electrode leads 220, which is a workpiece to be welded, from below, and may be formed as a flat structure to secure the joint area A. In addition, the lower clamp 11 may have a larger area than the joint area A.

Alternatively, the lower clamp 11 may be arranged to be able to move up and down in a vertical direction corresponding to the stacking direction of the plurality of electrode tabs 211 and the electrode leads 220. The lower clamp 11 may be installed to be able to move up and down using a pneumatic cylinder, a hydraulic cylinder, or the like as a driving source (not shown).

In addition, the present disclosure may round the upper surface edge of the lower clamp 11 that is in direct contact with the electrode tab 211 or the electrode lead positioned at the lowest end of the workpiece to be welded. The upper surface edge of the lower clamp 11 may be rounded to have a certain curvature in order to minimize defects such as deformation or damage of the electrode tab 211 or the electrode lead 220 that contacts the upper surface of the lower clamp 11 when the lower clamp 11 moves up or down.

The present disclosure includes the upper clamp 12 positioned opposite the lower clamp 11 described above.

The upper clamp 12 is placed above the lower clamp 11, and may be placed above the joint area A of the electrode tabs 211 and the electrode lead 220 mounted on the lower clamp 11 as shown in FIG. 3. That is, the upper clamp 12 is a component that enables welding by pressing down the electrode tabs 211 and the electrode lead 220 supported on the lower clamp 11.

The present disclosure may move the upper clamp 12 up and down to press the joint area A to be fixed. The upper clamp 12 may be arranged to be able to move up and down in a vertical direction corresponding to the stacking direction of the plurality of electrode tabs 211 and the electrode leads 220. The upper clamp 12 may be installed to be able to move up and down using a pneumatic cylinder, a hydraulic cylinder, or the like as a driving source (not shown).

In addition, in the present disclosure, the plurality of electrode tabs 211 of the same polarity may be gathered and pressed by lowering the upper clamp 12 so that the electrode tabs 211 are bent toward the center of the stacking direction and pressed against each other to form a bundle of electrode tabs. Furthermore, in the present disclosure, the height of the formation of the electrode tab bundle may be adjusted by moving the upper clamp 12 and/or the lower clamp 11 up and down. This allows the height of the electrode tab bundle to be set to correspond to the height of the arrangement of a sealing portion that takes the electrode lead 220 out of the battery casing 230.

The present disclosure may round the lower surface edge of the upper clamp 12 that is in direct contact with the electrode lead 220 or the electrode tab 211 positioned at the highest end of the workpiece to be welded. The lower surface edge of the upper clamp 12 may be rounded to have a certain curvature in order to minimize defects such as deformation or damage of the electrode lead 220 or the electrode tab 211 that contacts the lower surface of the upper clamp 12 when the upper clamp 12 moves up or down.

In addition, in the present disclosure, the through hole 12a is formed inside the upper clamp 12 so that a laser beam may be emitted to the joint area A where one end of the plurality of electrode tabs 211, that is, the bundle of electrode tabs and the other end of the electrode lead 220 overlap. The upper clamp 12 is formed in a size and shape to uniformly press the outer perimeter of the joint area A, and may be formed in a tubular shape of a hollow square column as shown.

As previously described, according to the present disclosure, welding quality may be improved by performing non-contact laser welding, instead of ultrasonic welding, under a state where the joint area A is held by upper and lower clamps.

The present disclosure includes the laser generator 14 that enables welding by emitting a laser beam to the joint area A. In this specification, the laser generator described above is a known technology, and thus a detailed description thereof will be omitted.

The laser generator 14 may emit a laser beam toward the joint area A to bond the plurality of electrode tabs 211 and the electrode lead 220. The laser generator 14 is spaced apart from the upper clamp 12 placed on the joint area A, and the laser beam emitted from the laser generator 14 may pass through the through hole 12a of the upper clamp 12 and be vertically incident on the electrode tab 211 or the electrode lead 220. Referring to FIG. 3, as the laser beam is introduced into the plurality of electrode tabs 211 via the electrode tab 211, not only can the contact surfaces of the electrode lead 220 and the electrode tabs 211 be bonded as one piece, but also the bundle of electrode tabs (no reference numeral) formed by gathering the plurality of electrode tabs 220 can be bonded as one piece.

In addition, the present disclosure includes the mask 13 for emitting a laser beam to a certain area in the joint area A.

As shown, the mask 13 is interposed between the upper clamp 12 and the laser generator 14, but may be preferably positioned and fixed on the upper clamp 12. Alternatively, in the present disclosure, the upper clamp 12 and the mask 13 may be formed integrally. In the present disclosure, the opening 13a of the mask 13 and the through hole 12a of the upper clamp 12 may be aligned and fixed in the direction of emission of the laser beam.

As is well known to those skilled in the art, the mask 13 may have at least one opening 13a to allow the laser beam to be aimed at the workpiece to be welded, that is, the joint area A. Moreover, the opening 13a of the mask 13 are positioned within the range of the through hole 12a of the upper clamp 12 so that the laser beam can pass through the opening 13a of the mask 13 and the through hole 12a of the upper clamp 12 and be emitted to the joint area A, while the opening 13a and the through hole 12a are arranged in a row along the stacking direction of the joint area A.

Thus, according to the present disclosure, the mask 13 placed on the upper clamp 12 is used to emit a laser beam to a desired area (e.g., a certain area of the joint area A) to locally melt the electrode lead 220 and the electrode tab 211, and then, as the melted portion solidifies, reliable bonding of the electrode lead 220 and the electrode tab 211 may be realized.

As shown in FIG. 3, the present disclosure may bond the plurality of electrode tabs 211 and the electrode lead 220 by non-contact laser welding.

Ultrasonic welding applied in conventional technology requires mechanical pressure that leaves an indentation mark, and there is a risk of damage to a thin-film electrode tab due to the stress concentration that occurs. However, in the present disclosure, the joint area A may be uniformly pressed and fixed by means of the lower clamp 11 and the upper clamp 12, thereby maintaining the mechanical strength of the joint area, and since the joint area A may be welded by non-contact laser welding, maintenance of the laser welding apparatus may be easily performed.

As shown, in the present disclosure, the electrode lead 220 may be placed on the plurality of electrode tabs 211. Unlike in the drawing, in the present disclosure, the electrode lead 220 may be placed under the plurality of electrode tabs 211 or may be inserted and placed between the electrode tabs 211. Accordingly, the plurality of electrode tabs 211 and the electrode lead 220 may partially overlap to form the joint area A.

In the present disclosure, the joint area A of the plurality of electrode tabs 211 and the electrode lead 220 may be pressed in the vertical direction along the stacking direction by means of the lower clamp 11 and the upper clamp 12. For example, the lower clamp 11 may move upward along the stacking direction of the joint area A, and the upper clamp 12 may move downward along the stacking direction of the joint area A to gather the electrode tabs 211 while applying pressure in the vertical direction to form a bundle of electrode tabs. The electrode tabs 211 are firmly pressed together so that no gaps are created between the electrode tabs. In the present disclosure, the electrode tab bundle and the electrode lead 220 may be completely pressed by the pressure applied by the lower clamp 11 and the upper clamp 12. In the case that welding is performed with a gap between the electrode tabs and/or between the electrode tab bundle and electrode lead, pores may form within the weld due to the gap. These pores may reduce the weld strength, resulting in weld defects such as separation of the electrode tab bundle and electrode lead, or separation of the bond between the electrode tabs.

The present disclosure uses the lower clamp 11 and the upper clamp 12 to hold the joint area A as described above, preferably, the through hole 12a of the upper clamp 12 that provides a path for a laser beam to travel and the opening 13a of the mask 13 are positioned over the joint area A.

In addition, in the present disclosure, the position of the laser generator 14 may be adjusted so that a laser beam can be emitted to the joint area A through the opening 13a and the through hole 12a. Then, the workpiece to be welded is welded by means of the laser generator 14 while the plurality of electrode tabs 211 and the electrode lead 220 are in close contact with each other.

The laser beam is focused on a specific area of the joint area A through the opening 13a of the mask 13 and the through hole 12a of the upper clamp 12, thereby forming a plurality of welded portions W in the joint area A. The electrode tabs 211 and the electrode lead 220 may be joined by being heated, melted, and solidified by the emitted laser beam to form the welded portions W.

As previously described, in order for the laser beam to pass through the opening 13a and the through hole 12a and be emitted to the joint area A, the opening 13a of the mask 13 as well as the through hole 12a of the upper clamp 12 are positioned within the range of the joint area A, and the opening 13a and the through hole 12a are arranged in the vertical direction corresponding to the emission direction of the laser beam. Moreover, the opening 13a of the mask 13 may be formed in a through-hole structure through which a laser beam can pass through the mask 13 and be emitted to the joint area A, and has a position and pattern corresponding to the position and pattern of the plurality of welded portions W. For reference, the opening 13a may also be formed in a slit structure.

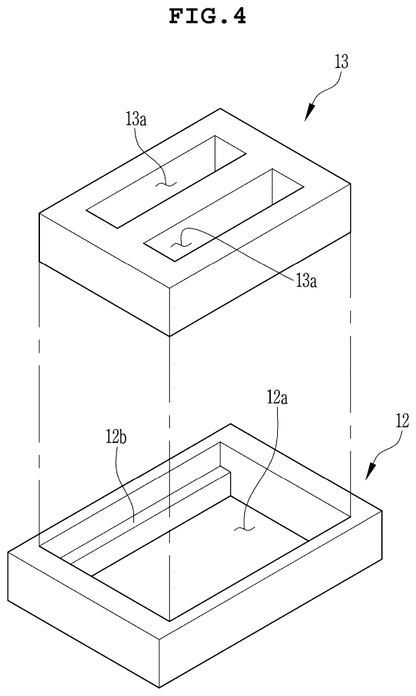

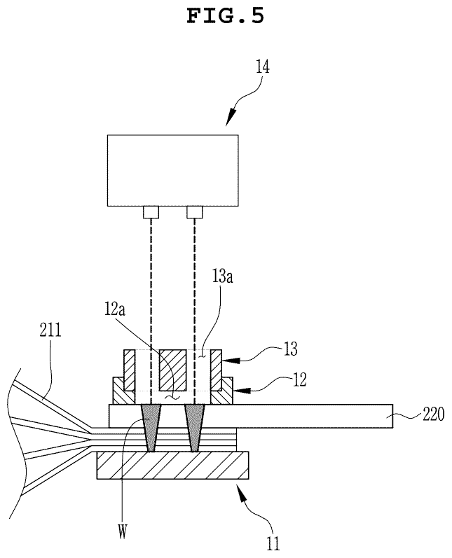

A laser welding apparatus for a secondary battery according to another embodiment of the present disclosure will be described with reference to FIGS. 4 and 5.

FIG. 4 is a schematic view showing the main parts of a laser welding apparatus for a secondary battery according to another embodiment of the present disclosure, and FIG. 5 is a cross-sectional view schematically showing a process of bonding a plurality of electrode tabs and an electrode lead using a laser welding apparatus for a secondary battery according to another embodiment of the present disclosure.

As is widely known, a laser beam may generate a large amount of spatter during the process of melting the electrode tabs 211 and the electrode lead 220, and the mask 13 is inevitably contaminated due to the scattering of the aforementioned spatter. As welding progresses, the mask 13 needs to be replaced periodically because the spatter adheres to the surface of the mask and covering the opening 13a.

Accordingly, the laser welding apparatus for a secondary battery according to another embodiment of the present disclosure may be configured to be able to detachably mount the mask 13 on the upper clamp 12 and at the same time ensure alignment of the mask 13 when mounting the mask 13 on the upper clamp 12.

The upper clamp 12 has a stepped portion 12b on the inner surface of the through hole 12a, so that the upper side of the through hole 12a may be expanded in a stepped manner. This allows the upper side of the through hole 12a to have a greater width than the lower side of the through hole 12a, thereby allowing the introduction of the mask 13 into the upper side of the through hole 12a. In addition, the lower edge of the mask 13 may be supported by the stepped portion 12b to limit the insertion depth of the mask 13 and provide a separation distance between the mask 13 and the joint area A. Alternatively, the present disclosure may also form a stepped portion at the bottom of the mask 13 so that the bottom of the mask 13 may be fixedly joined to the stepped portion 12b.

In the present disclosure, since the upper side of the through hole 12a is formed in a size and shape corresponding to the bottom of the mask 13, the bottom of the mask 13 may be joined in a forced fit manner within the through hole 12a, thereby preventing unnecessary rotation of the mask 13 and ensuring alignment of the mask 13.

In addition, the opening 13a of the mask 13 is formed in the thickness direction, specifically in the stacking direction of the joint area A, in the inner central region of the mask 13 corresponding to the lower side of the through hole 12a so as not to be covered by the stepped portion 12b of the upper clamp 12.

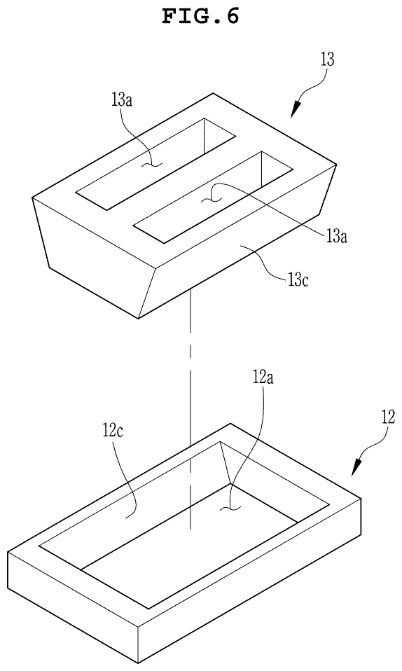

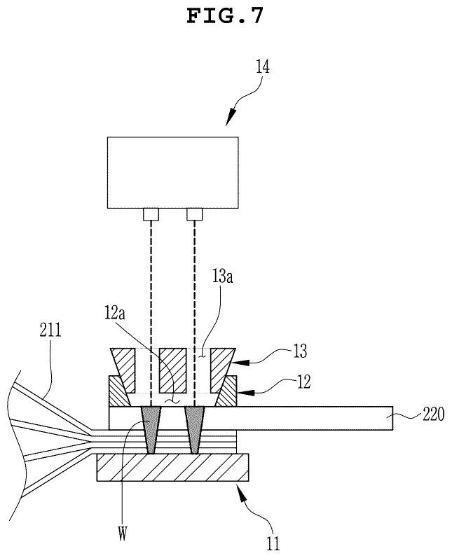

A laser welding apparatus for a secondary battery according to still another embodiment of the present disclosure is similar to the above-described embodiment except for the method of joining the mask and the upper clamp, as illustrated in FIGS. 6 and 7. Thus, to facilitate a clear understanding of the present disclosure, descriptions of similar or identical components will be omitted herein.

FIG. 6 is a schematic view showing the main parts of a laser welding apparatus for a secondary battery according to still another embodiment of the present disclosure, and FIG. 7 is a cross-sectional view schematically showing a process of bonding a plurality of electrode tabs and an electrode lead using a laser welding apparatus for a secondary battery according to still another embodiment of the present disclosure.

In the laser welding apparatus for a secondary battery according to still another embodiment of the present disclosure, the through hole 12a of the upper clamp 12 may be formed with a trapezoidal cross-section shape.

As shown in FIG. 7, the through hole 12a may be formed with a trapezoidal cross-section shape with a width that gradually narrows from top to bottom. Preferably, the through hole 12a may be formed in a cross-sectional shape of an isosceles trapezoid with symmetrically arranged inner slopes 12c that are not parallel to each other on opposite sides.

In still another embodiment of the present disclosure, the through hole 12a may be formed in a shape corresponding to the bottom of the mask 13 in order to align with the bottom of the mask 13. To this end, the bottom of the mask 13 may also have a trapezoidal cross-section shape with a top-bottom narrowing structure so as to be in close contact with the inner slopes 12c described above. That is, the bottom of the mask 13 may be formed in a cross-sectional shape of an isosceles trapezoid with symmetrically arranged outer slopes 13c that are not parallel to each other on opposite sides.

In still another embodiment of the present disclosure, the outer slope 13c and the inner slope 12c are arranged to be inclined at angles that match each other, so that the outer slopes 13c of the mask 13 and the inner slopes 12c of the upper clamp 12 may be maintained in mutually facing contact. In addition, the inner slopes 12c of the upper clamp 12 may be arranged facing in the length direction of the electrode lead 220, whereas the outer slopes 13c of the mask 13 may be arranged facing in the length direction of the electrode lead 220.

Accordingly, the laser welding apparatus for a secondary battery according to still another embodiment of the present disclosure may not only easily mount the bottom of the mask 13 to the upper clamp 12, but also easily remove the bottom of the mask 13 from the upper clamp 12. Furthermore, in the laser welding apparatus for a secondary battery according to still another embodiment of the present disclosure, the mask 13 may be installed so as to be displaced upward or downward along the perforation direction of the through hole 12a of the upper clamp 12.

For example, when the mask 13 is placed in the through hole 12a of the upper clamp 12, the mask 13 may be misaligned as the upper clamp 12 is deformed by the high heat from the laser beam. Moreover, the mask 13 is inevitably affected by stress due to the thermal deformation of the upper clamp 12. According to the laser welding apparatus for a secondary battery according to still another embodiment of the present disclosure, in order to minimize the influence of stress applied to the mask 13, the mask 13 may be forcibly moved upward along the inner slopes 12c of the through hole 12a, thereby ensuring removal of the mask 13 from the upper clamp 12 and reuse of the upper clamp 12.

Above, the present disclosure has been described in detail through specific embodiments. The embodiments are for specifically explaining the present disclosure, and are only illustrative and do not limit the scope of the appended claims. It will be readily apparent that modifications and improvements within the technical scope of the present disclosure are possible for those skilled in the art.

All simple modifications or changes of the present disclosure fall within the scope of the present disclosure, and the specific scope of protection of the present disclosure will be made clear by the appended claims.

What is claimed is:

1. A laser welding apparatus for a secondary battery, the apparatus comprising:
a lower clamp configured to support a joint area of a plurality of electrode tabs extending from an electrode assembly and an electrode lead stacked on the plurality of electrode tabs;
an upper clamp configured to press the joint area of the plurality of electrode tabs and the electrode lead and to have a through hole therein; and
a laser generator configured to emit a laser beam,
wherein the laser beam passes through the through hole to weld the plurality of electrode tabs and the electrode lead to enable electrical connection.

2. The apparatus of claim 1, wherein the lower clamp is arranged to be able to move up and down.

3. The apparatus of claim 1, wherein the upper clamp is positioned opposite to the lower clamp and is arranged to be able to move up and down.

4. The apparatus of claim 1, further comprising:
a mask interposed between the upper clamp and the laser generator, and configured to have at least one opening therein through which the laser beam passes.

5. The apparatus of claim 4, wherein the opening and the through hole are arranged in a row along a stacking direction of the joint area.

6. The apparatus of claim 4, wherein the mask is detachably mounted on the upper clamp.

7. The apparatus of claim 6, wherein the upper clamp is provided with a stepped portion on an inner surface of the through hole so that an upper side of the through hole is expanded stepwise.

8. The apparatus of claim 7, wherein the upper side of the through hole is formed with a size and shape corresponding to a bottom of the mask.

9. The apparatus of claim 6, wherein the through hole of the upper clamp is formed with a trapezoidal cross-section with a width that gradually narrows from top to bottom, and
the bottom of the mask is formed with a trapezoidal cross-section to correspond to the through hole.

10. The apparatus of claim 9, wherein the through hole is formed in a cross-sectional shape of an isosceles trapezoid with symmetrically arranged inner slopes that are not parallel to each other on opposite sides, and
the bottom of the mask is formed in a cross-sectional shape of an isosceles trapezoid with symmetrically arranged outer slopes that are not parallel to each other on opposite sides.
